(19) United States
(12) Patent Application Publication
(10) Pub. No.: US 2024/0067807 A1
(43) Pub. Date: Feb. 29, 2024

(54) POLYMER COMPOSITION

(71) Applicant: Dow Global Technologies LLC, Midland, MI (US)

(72) Inventors: Bhawesh Kumar, Sugar Land, TX (US); Alex Stolarz, Walenstadtberg (CH)

(21) Appl. No.: 18/250,374

(22) PCT Filed: Dec. 14, 2021
(86) PCT No.: PCT/US2021/063381

§ 371 Date: Apr. 28, 2023

Related U.S. Application Data
(60) Provisional application No. 63/127,810, filed on Dec. 18, 2020.

(51) Int. Cl. C08L 23/06; C08K 3/04

(52) U.S. Cl. CPC C08L 23/06; C08K 3/04; C08L 2203/18; C08L 2205/025

(57) ABSTRACT

A high strength multimodal polyethylene composition useful for manufacturing a plastic article therefrom, the composition including a mixture of: (a) at least one first polymer resin comprising a high molecular weight copolymer resin having a molecular weight of greater than 350,000 g/mol; (b) at least one second polymer resin comprising a low molecular weight homopolymer resin having a molecular weight of less than 30,000 g/mol; and (c) at least one third polymer resin comprising a medium molecular weight copolymer resin having a molecular weight of from 50,000 g/mol to 150,000 g/mol; wherein the high strength multimodal polyethylene composition has minimum required strength of greater than 11.3 MPa; a process for producing the above composition; and a pipe article made from the above composition.

### FIELD

The present invention relates to a polymer composition; and more specifically, the present invention relates to a high strength polyethylene polymer composition including a combination of at least three different polyethylene polymers having three different molecular weights. The high strength polyethylene polymer composition is useful for various applications such as for water and gas transportation pipes.

### BACKGROUND

Heretofore, various polymer compositions have been used to make various articles/products that require high mechanical performance. For example, plastic pipes are articles that require a high strength (e.g., a high pressure stress level in terms of minimum required strength (MRS) of greater than 10 MPa) for certain high pressure applications.

It is common in the plastics pipe industry to use “PE 100” pipe grade which is readily available in the plastic pipe industry. “PE 100” is a pipe grade polyethylene (PE); and typically has an optimum balance of the following three key properties: (1) minimum required strength (MRS), which for PE 100 is typically 10 MPa as defined in the EN ISO 12162; wherein the MRS provides long-term strength and creep resistance to the pipe; (2) stress crack resistance (sometimes referred to as slow crack growth resistance [SCGR]) which is typically >500 hr when tested on a notched pipe at 80° C. and 9.2 bar; and (3) rapid crack propagation resistance which is typically measured in terms of crack arrest at 10 bar pressure at 0° C.

A polyethylene polymer resin having a higher strength (i.e., higher MRS) than PE 100 is known in the art as “PE 112” pipe grade resin. Typically, such PE 112 resins have a pressure rating, i.e., a MRS of 11.2 MPa. However, PE 112 resins have not gained wide and common usage in the plastic pipe manufacturing industry even though three commercial PE 112 pipe grade resins are currently available from suppliers such as SCG Polymer, SABIC, and Sinopec. In addition, a MRS of 11.2 MPa or possibly higher is not a common value achieved for pressure pipe resins used in the plastic pipe manufacturing industry because any increase in MRS for pipe resins in increments of 0.1 MPa is very difficult to achieve because to produce a PE polymer resin material with an increase MRS requires a proper molecular design and an increase of the tie chain densities of the PE material to a level where long-term creep resistance is significantly higher than pressure pipe resins having a MRS of 10.0 MPa (e.g. PE 100 resins) or even higher than pressure pipe resins having a MRS of 11.2 MPa (e.g. PE 112 resins).

The sought-after polymer resins having the highest MRS possible (e.g., a MRS of 11.2 MPa or higher), such as PE 112 resins which are used for manufacturing plastic pipes, are desirable since the higher MRS enables the use of such high pressure pipe resins in applications requiring an MRS of greater than the standard PE 100 resin. For example, pipes made from PE 112 resin can be used in underwater applications. Also, a PE 112 pipe resin has the benefit of providing the option to down gauge the wall thickness of the pipe to be used.

Some advances have previously been made in modifying PE pipe resins for use in manufacturing pipes such that the manufactured pipes can be used in high performance applications. For example, patent application publication WO 2020/232006A1 discloses use of high density polyethylene (HDPE) resin for manufacturing pressure pipes, in which one or more variables of the pipe resin's high density polyethylene base polymer and/or its masterbatch are optimized to improve strength and performance for the creation of next generation pressure pipes. The above publication discloses that such optimization increases the MRS and creep performance of the resulting pipe made from such HDPE resin.

The above reference further discloses that base polymers and/or carbon black masterbatches (the masterbatch having a carrier resin and carbon black) are formulated to create pipe resins. The above reference discloses improving a pipe resin's physical properties and its performance by: (1) increasing the density and/or molecular weight of the base polymer for use with standard masterbatches to reach a PE 112 designation; and/or (2) increasing the density and/or molecular weight of the carrier resin in the masterbatch, without changing the carbon black characteristics, so that the masterbatch can be used with standard base polymers to reach a PE 112 designation. Once modified, the base polymer and masterbatch are blended together to form a resultant polymer resin that can be extruded as the next generation of pipes. The resultant polymer resin formed by blending a base polymer and a black masterbatch disclosed in WO 2020/232006A1 is a high strength resin with a MRS of at least 11.2 MPa and up to 11.3 MPa. In addition, the high strength resin described in the above reference is a blend of a bimodal, high molecular weight, high density polyethylene base polymer having a density between 0.947 g/cm3 and 0.952 g/cm3 and a masterbatch comprising a carrier resin and carbon black wherein the masterbatch has a density between 1.1 g/cm3 and 1.4 g/cm3 and a carbon black with a particle size range of less than 55 nm.

Other references including, for example, U.S. Pat. Nos. 7,989,549; 7,416,686B2; 9,234,061B2; 7,868,092; and U.S Patent Application Publication US20090252910A1 disclose various polyethylene-based polymer compositions having various MRS values from 9.0 MPa to 11.2 MPa for manufacturing pipes. However, none of the above references provide an improved multimodal (at least a trimodal) polymer resin composition with improved properties (e.g., molecular weight and density) to increase the pressure performance (e.g., a design stress beyond 11.2 MPa) of a pipe article made from the polymer composition.

It is therefore, desired to provide a multimodal, for example at least a trimodal polyethylene polymer resin composition, that has a designation, according to the plastics pipe industry, of higher than a standard “PE 100” pipe grade resin, and equal to or higher than a “PE 112” pipe grade resin having an increase in MRS even higher than the MRS of 11.2 MPa disclosed in WO 2020/232006A1.

### SUMMARY

The present invention is directed to a high strength multimodal polyethylene polymer composition useful for manufacturing a plastic article, such as a pipe member.

In one embodiment, the present invention includes a high strength multimodal (e.g. at least a trimodal) polyethylene polymer composition useful for manufacturing plastic articles such as pipe member, the composition comprising a mixture of: (a) at least one first polymer resin comprising a high molecular weight (HMW) copolymer resin having a molecular weight of greater than 350,000 g/mol; (b) at least one second polymer resin comprising a low molecular weight (LMW) homopolymer resin having a molecular weight of less than 30,000 g/mol; and (c) at least one third polymer resin comprising a medium molecular weight (MMW) copolymer resin having a medium molecular weight of from 50,000 g/mol to 150,000 g/mol; wherein the high strength multimodal polyethylene composition has a minimum required strength (MRS) of greater than 11.3 MPa in one general embodiment, and greater than or equal to 11.5 MPa in another embodiment.

In another embodiment, the present invention includes a process for producing the above high strength polyethylene composition.

In still another embodiment, the present invention includes a pipe member made from the above high strength polyethylene composition.

One objective of the present invention is to provide a novel trimodal high strength polyethylene composition useful for producing a pipe member from the composition, wherein the composition has a MRS of at least greater than 11.3 MPa in one embodiment, and at least greater than or equal to 11.5 MPa in still another embodiment. In accordance with the present invention, the pipe member can be manufactured using the above novel composition, wherein the pipe member has the applicable design stress of greater than 9.0 MPa after considering a C of 1.25 to perform in high-pressure applications.

### DETAILED DESCRIPTION

Temperatures herein are in degrees Celsius (° C.).

“Room temperature (RT)” and/or “ambient temperature” herein means a temperature between 20° C. and 26° C., unless specified otherwise.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer,” which includes copolymers (employed to refer to polymers prepared from two different types of monomers), terpolymers (employed to refer to polymers prepared from three different types of monomers), and polymers prepared from more than three different types of monomers. Trace amounts of impurities, for example, catalyst residues, may be incorporated into and/or within the polymer. It also embraces all forms of copolymer, e.g., random, block, etc. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A “pipe-forming composition” herein means a composition capable of being processed into a pipe article, member or structure.

“Minimum required strength (MRS)” herein means predicted hydrostatic strength, with 97.5% lower confidence limit, at a temperature of 20° C. and 50 years. MRS is determined by performing regression analysis in accordance with ISO 9080 on the test data from the results of long-term pressure testing. The regression analysis allows for the prediction of the minimum strength for a specific service lifetime. The data is extrapolated to predict the minimum strength at 20° C. and at the specified 50-year design lifetime.

“PE 100” is designation for categorizing a pipe grade polyethylene (PE) resin. The designation PE 100 is based on the long-term strength of a polyethylene, known as the minimum required strength (MRS) in accordance with ISO 12162-1; and the designation PE 100 is for a pipe grade PE resin having a minimum MRS of 10 MPa extrapolated at RT for 50 years lifetime. Besides a MRS of 10 MPa (1450 psi), some of the other properties (in accordance with PE4710 pipe category meeting ASTM D3350 cell classification) of a PE100 designated pipe include, for example: (1) hydrostatic design basis (HDB) pressure: 1600 psi (11 MPa); (2) allowable compressive strength: 7.93 MPa; (3) tensile strength at yield: 23 MPa; (4) elongation at break: >600%; (5) modulus of elasticity (50 years): 200 MPa; (6) flexural modulus: 1,000 MPa; (7) Poisson's Ratio: 0.45; (8) Coefficient of Thermal Expansion (CTE): 1.3×10-4° C.-1; and (9) a temperature resistance of up to 60° C.

The term “design stress” herein, with reference to a pipe member, means an allowable stress for a given stress for a given application at 20° C. that is derived from the MRS by dividing MRS by C. A typical C for pressure pipes conveying water is 1.25 for polyethylene pipe resins as defined in the EN ISO 12162.

The term “unimodal” herein, with reference to a polyethylene polymer, means a polymer having a single polyethylene component with one peak in the molecular weight distribution as measured in GPC analysis.

The term “bimodal” herein, with reference to a polyethylene polymer, means a polymer having two polyethylene components having two molecular weight peaks in the molecular weight distribution as measured in GPC analysis.

The term “trimodal” herein, with reference to a polyethylene polymer, means a polymer having three polyethylene components having three molecular weight peaks in the molecular weight distribution as measured in GPC analysis.

The term “multimodal” herein, with reference to a polyethylene polymer, means a polymer having at least three or more polyethylene components with molecular weight peaks in the molecular weight distribution as measured in GPC analysis.

By “high strength” with reference to a pipe member herein it is meant a high pressure (or high MRS) rating generally greater than 11.2 MPa.

The term “composition” refers to a mixture of materials which comprise the composition, as well as reaction products and decomposition products formed from the materials of the composition.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; etc.).

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

As used throughout this specification, the abbreviations given below have the following meanings, unless the context clearly indicates otherwise: “=” means “equal(s)” or “equal to”; “<” means “less than”; “>” means “greater than”; “≤;” means “less than or equal to”; ≥” means “greater than or equal to”; “˜” means “approximately”; “@” means “at”; μm=micron(s), nm=nanometer(s); g=gram(s); mg=milligram(s); kg=kilogram(s); mW/m-K=milliWatt(s) per meter-degree Kelvin; L=liter(s); mL=milliliter(s); g/mL=gram(s) per milliliter; g/L=gram(s) per liter; kg/m3=kilogram(s) per cubic meter; g/m3=gram(s) per cubic meter; g/cm3=gram(s) per cubic centimeter; ppm=parts per million by weight; pbw=parts by weight; rpm=revolutions per minute; m=meter(s); m/min=meter(s) per minute; mm=millimeter(s); cm=centimeter(s); m=micrometer(s); min=minute(s); s=second(s); ms=millisecond(s); hr=hour(s); kPa-s=kiloPascal second(s); MPa=megapascal(s); Pa-s=Pascal second(s); mPa-s=milliPascal second(s); g/mol=gram(s) per mole(s); g/eq=gram(s) per equivalent(s); mg KOH/g=milligrams of potassium hydroxide per gram(s); Mn=number average molecular weight; Mw=weight average molecular weight; pts=part(s) by weight; 1/s or sec-1=reciprocal second(s) [s-1]; ° C.=degree(s) Celsius; mmHg=millimeters of mercury; psig=pounds per square inch; kPa=kilopascal(s); %=percent; vol %=volume percent; mol %=mole percent; dg/min=decigram(s) per minute; g/10 min=gram(s) per 10 minutes; MHz=megahertz; wt %=weight percent; 1/min or min-1=inverse of minute; and M or mol/L=molar.

Unless stated otherwise, all percentages, parts, ratios, and the like amounts, are defined by weight. For example, all percentages stated herein are weight percentages (wt %), unless otherwise indicated.

In one general embodiment, the present invention includes a high strength multimodal polyethylene composition comprising: (a) at least one first polymer resin comprising a high molecular weight (HMW) polyethylene copolymer, wherein the first polyethylene copolymer has a HMW of greater than 350,000 g/mol; (b) at least one second polymer resin comprising a low molecular weight (LMW) polyethylene homopolymer, wherein the second polyethylene homopolymer has a LMW of less than 30,000 g/mol; and (c) at least one third polymer resin comprising a medium molecular weight (MMW) polyethylene copolymer, wherein the third polyethylene copolymer has a MMW of from 50,000 g/mol to 150,000 g/mol. Other optional compounds can be added to the above composition if desired, such as (d) a carbon black material provided from a carbon black masterbatch.

The first HMW ethylene copolymer, component (a) of the high strength polyethylene composition of the present invention, can include one or more polyethylene copolymers of differing molecular weights. Generally, the molecular weight of the first HMW polyethylene copolymer is from 300,000 g/mol to 10,000,000 g/mol in one embodiment, from 300,000 g/mol to 5,000,000 g/mol in another embodiment, and from 300,000 g/mol to 1,000,000 g/mol in still another embodiment.

In one preferred embodiment, the first HMW ethylene copolymer useful in the present invention can be ethylene-hexene copolymer, ethylene-butene copolymer, ethylene-octene copolymer, or mixtures thereof which are polymerized in the first reactor.

In addition to having a high molecular weight, the first HMW ethylene copolymer has a density of greater than 0.920 g/cm3 in one embodiment, from 0.920 g/cm3 to 0.935 g/cm3 in another embodiment, and from 0.920 g/cm3 to 0.931 g/cm3 in another embodiment. Also, the first HMW ethylene copolymer has a I21 of greater than 0.30 dg/min in one embodiment, and from 0.30 dg/min to 0.50 dg/min in another embodiment. In one preferred embodiment, the second HMW copolymer useful in the present invention can have density greater than 0.920 g/cm3 and I21 greater than 0.30 dg/min.

Exemplary of one advantageous property exhibited by the first HMW polyethylene copolymer of the present invention includes providing a slow crack growth resistance that depends on the tie chain density which is a function of the presence of comonomers.

The concentration of the first HMW polyethylene copolymer in the present invention includes, for example, from 50 wt % to 65 wt % in one embodiment, from 50 wt % to 60 wt % in another embodiment, and from 50 wt % to 57 wt % in still another embodiment.

The second LMW ethylene homopolymer, component (b) of the high strength polyethylene composition of the present invention, can include one or more ethylene homopolymers of differing molecular weights. Generally, the molecular weight of the second LMW ethylene homopolymer is from 1,000 g/mol to 60,000 g/mol in one embodiment, from 1,000 g/mol to 40,000 g/mol in another embodiment, and from 1,000 g/mol to 30,000 g/mol in still another embodiment.

In addition to having a low molecular weight, the second LMW ethylene homopolymer has a high density of greater than 0.960 g/cm3 in one embodiment, from 0.960 g/cm3 to 0.972 g/cm3 g/cm3 in another embodiment, and from 0.965 g/cm3 to 0.972 g/cm3 in still another embodiment. Also, the second LMW ethylene homopolymer has a I2 of greater than 100 dg/min in one embodiment, from 100 dg/min to 1,000 dg/min in another embodiment, and from 300 dg/min to 1,000 dg/min in still another embodiment. In one preferred embodiment, the second LMW, high density ethylene homopolymer useful in the present invention can have density greater than 0.960 g/cm3 and I2 greater than 100 dg/min.

The concentration of the second LMW polyethylene homopolymer useful in the present invention includes, for example, from 35 wt % to 50 wt % in one embodiment, from 35 wt % to 45 wt % in another embodiment, and from 35 wt % to 40 wt % in still another embodiment.

The third MMW polyethylene copolymer, component (c) of the high strength polyethylene composition of the present invention, can include one or more polyethylene copolymers of differing molecular weights. Generally, the molecular weight of the third MMW polyethylene copolymer is from 60,000 g/mol to 500,000 g/mol in one embodiment, from 60,000 g/mol to 400,000 g/mol in another embodiment, and from 60,000 g/mol to 300,000 g/mol in still another embodiment.

In addition to having a medium molecular weight, the third MMW ethylene copolymer has a density of greater than 0.915 g/cm3 in one embodiment, from 0.915 g/cm3 to 930 g/cm3 in another embodiment, and from 0.915 g/cm3 to 0.925 g/cm3 in still another embodiment. Also, the third MMW ethylene copolymer has a I2 of greater than 0.5 dg/min in one embodiment, from 0.5 dg/min to 2.5 dg/min in another embodiment, and from 0.5 dg/min to 1.5 dg/min in still another embodiment. In one preferred embodiment, the third MMW copolymer useful in the present invention can have density greater than 0.915 g/cm3 and I2 greater than 0.5 dg/min.

In one preferred embodiment, the third MMW polyethylene copolymer useful in the present invention can be linear low density polyethylene. The third MMW polyethylene copolymer of the present invention includes 1-octene comonomer and the presence of the 1-octene in combination with the other comonomer (1-hexene) provides the advantageous properties described in the Examples.

The concentration of the third MMW polyethylene copolymer useful in the present invention includes, for example, from 2 wt % to 6 wt % in one embodiment, from 2 wt % to 5 wt % in another embodiment, and from 2 wt % to 4 wt % in still another embodiment.

In other embodiments, the high strength polyethylene composition of the present invention can include one or more various optional compounds, as component (d) of the high strength polyethylene composition of the present invention. For example, the optional compounds useful in the present invention can include carbon black; primary and secondary antioxidants; and mixtures thereof.

The concentration of the optional compounds, when used in the present invention can be, for example, from 0 wt % to 5 wt % in one embodiment, from 1 wt % to 4 wt % in another embodiment, and from 2 wt % to 3 wt % in still another embodiment.

In one preferred embodiment, the high strength polyethylene composition of the present invention can include, for example, a carbon black material as optional component (d). Carbon black is used to prevent ultraviolet (UV) degradation of polymer. For polyethylene pipes, the average particle size of the carbon black can be less than 60 nm in one embodiment, and less than 30 nm in another embodiment. In other embodiments, the average particle size of the carbon black is less than 25 nm in one embodiment, and from 10 nm to 25 nm in another embodiment in accordance with the requirement described in EN 12201-1.

In another preferred embodiment, the carbon black used in the high strength polyethylene composition can be obtained from a carbon black masterbatch. The carbon black masterbatch is a blend of carbon black and a carrier resin. The carrier resin can be, for example, high density polyethylene, linear low density polyethylene, and mixtures thereof. The carrier resin can have a unimodal or bimodal molecular weight distribution. The carbon black masterbatch can also have a primary and/or secondary antioxidant to prevent thermal oxidation.

Generally, the carrier resin used in the present invention has a lower density and a lower molecular weight when compared to the base resin in the high strength multimodal polyethylene composition, contrary to some prior art such as WO 2020/232006A1 which discloses increasing the density and/or molecular weight of the carrier resin in the masterbatch.

Generally, the masterbatch can be produced by compounding the carrier compound with the carbon black. For example, 60 wt % of a carrier resin is compounded with 40 wt % of carbon black. Conventional equipment and processes can be used to carry out the compounding including, for example, an extruder such as a twin-screw extruder, or a batch mixer.

The concentration of the carbon black compound from the carbon black masterbatch, when used in the present invention includes, for example, from 2 wt % to 5 wt % in one embodiment, from 2 wt % to 3 wt % in another embodiment, and from 2 wt % to 2.5 wt % in still another embodiment. UV degradation of the polymer used for pipe application cannot be prevented if carbon black content is less than 2 wt %. Above 5 wt % of carbon black, premature failure may occur during long term hydrostatic tests on pipe.

The polymerization process of the present invention provides a high strength multimodal polyethylene composition that has properties equal to or greater than a polyethylene composition categorized as PE 100 or PE 112 with no knee and that performs beyond the current conventional polyethylene composition categorized as PE 100 or PE 112.

Some advantageous properties and/or benefits of the high strength polyethylene composition of the present invention include, for example, ease of processability during pipe extrusion in manufacturing a pipe member due to higher MFR5 that results in lower extruder and die head pressure as compared to commercial PE 112 products. For example, the composition provides a higher output and a higher throughput using known processing equipment and parameters such as known pipe extrusion processes used to process conventional PE 100 resin. In one embodiment, for example, the polyethylene composition of the present invention provides efficient processing and better productivity because the polyethylene composition has a viscosity such that a single screw extruder can be used wherein melting occurs primarily as a result of viscous dissipation (or shearing) of polymer. And, in terms of the procedure for processing the polyethylene composition of the present invention, the polyethylene composition is processed more similarly to the processing of a conventional PE100 resin; however, the polyethylene composition of the present invention is processed at a higher output and throughput at a lower die pressure compared to currently available for resins classified as PE 112.

In general, the polyethylene composition exhibits, for example, an MFR of from 0.2 dg/min to 0.5 dg/min in one embodiment, from 0.25 dg/min to 0.5 dg/min in another embodiment, and from 0.3 dg/min to 0.5 dg/min in still another embodiment as measured @ 190° C. and 5 kg. In one preferred embodiment, the composition has an MFR of 0.31 dg/min @ at 190° C. and 5 kg. The composition of the present invention having an MFR 0.31 dg/min is significantly better flowing and processing than the state-of the art resins described Table I of the Examples having an MFR of 0.20 g/10 min at 190° C. and 5 kg.

In addition, the composition of the present invention can be used to manufacture a pipe product that has a much higher MRS than needed to qualify for a PE 112 classification, for example, the composition provides at least 15% increase in MRS strength compared to PE100 in one general embodiment, and from ≥15% up to 25%. From a regression curve, the strength of the polyethylene composition of the present invention can be determined; and no knee point can be shown on a regression curve in each temperature testing for a testing time up to 10,000 hr. Thus, the polyethylene composition of the present invention has, for example, a MRS rating of >11.3 MPa @ 50 years in one embodiment, and >11.5 MPa @ 50 years in another embodiment. The test result of long-term hoop stress of the material is used. With a 17% higher pressure compared to PE100, the polyethylene composition of the present invention can provide an additional safety factor and a prolonged application lifetime.

Polyethylene (PE) is a thermoplastic material and in general is produced from the polymerization of ethylene. The general process for producing the high strength multimodal (e.g. a trimodal) polyethylene composition of the present invention includes admixing: (a) at least one first polymer resin comprising a polyethylene copolymer resin having a HMW of greater than 350,000 g/mol; (b) at least one second homopolymer resin comprising a polyethylene homopolymer resin having a LMW of less than 30,000 g/mol; and (c) at least one third polymer resin comprising a polyethylene copolymer resin having an MMW of from 50,000 g/mol to 150,000 g/mol and (d) optionally, a carbon black material from a carbon black masterbatch; wherein the mixture is processed to form a high strength multimodal polyethylene composition; wherein the resulting high strength multimodal polyethylene composition is useful for manufacturing a pipe member having a MRS of greater than or equal to 11.2 MPa. Generally, the components (a) to (c) and optionally (d) of are mixed at a temperature of from 170° C. to 260° C. in one general embodiment; from 180° C. to 250° C. in another embodiment; and from 190° C. to 240° C. in still another embodiment. Conventional mixing equipment can be used to form high strength multimodal polyethylene composition.

In one preferred embodiment, the process for producing the high strength multimodal polyethylene composition includes the steps of:
(I) mixing components (a) to (c) and optionally (d); and
(II) forming the mixture of step (I) into pellets; wherein the pellets can be further processed into an article such as a pipe product.

In another preferred embodiment, the process includes for example the steps of: (i) mixing components (a) and (b) separate from components (c) and (d) in a conventional reactor to form a first mixture, (ii) mixing components (c) and (d) using various compounding equipment known in the art that include a pelletization means to form blend or second mixture of components (c) and (d); (iii) compounding the first mixture of components (a) and (b) with the second mixture of components (c) and (d) using known compounding equipment that has a pelletization step; and (iv) pelletizing the compounded components (a)-(d) using a conventional pellet forming equipment to form pellets of the high strength polyethylene composition. The resulting pellets of the high strength multimodal polyethylene composition formed in step (iv) can then processed to convert the pellets using conventional equipment to form a pipe member. For example, the resulting PE pellets can be extruded by means of an extruder with a proper die to form a pipe member; or the resulting PE pellets can be formed into other desired articles using conventional coextrusion processes and equipment.

One of the advantageous benefits of using the above-described process for making the composition of the present invention includes, for example, the process allows introducing a third polymer resin component by blending the third polymer resin such as the component (c) and an optional component such as carbon black, component (d), through a carbon black masterbatch instead of using a third reactor in series. The aforementioned advantage of using the process is to achieve trimodality without the requirement of using three reactors. Also, the final product can be made on a conventional pellet forming unit.

In general, the process for producing the article, such as pipe member, of the present invention includes, for example, the steps of: (i) providing a high strength multimodal, such as a trimodal, polyethylene composition useful for manufacturing a plastic article such as pipe member, the composition comprising a mixture of: (a) at least one first polymer resin comprising a copolymer resin having a molecular weight of greater than 350,000 g/mol; (b) at least one second polymer resin comprising a homopolymer resin having a molecular weight of less than 30,000 g/mol; and (c) at least one third polymer resin comprising a copolymer resin having a molecular weight of from 50,000 g/mol to 150,000 g/mol; wherein the high strength trimodal polyethylene composition has minimum required strength of greater than 10 MPa; and (ii) processing the composition of step (i) into an article, such as a pipe member, using an extrusion process to form the article; wherein the article, such as a pipe member, has a minimum required strength of greater than 10 MPa. The processing step (ii) for manufacturing the high strength PE plastic pipe includes, for example, forming pellets from the composition using a pelletization unit; and then processing the pellets with an extruder using an extrusion process as aforementioned.

The high strength multimodal polyethylene polymer composition of the present invention described above can be used to make various articles or products that require an increase in MRS for an application. In a preferred embodiment, the article produced from the composition described above is, for example, a pipe member. The resulting pipe member produced using the composition and the process described above, after undergoing the production process, has several advantageous and beneficial properties compared to some of the previously known pipe products. For example, the pipe member manufactured from the high strength polyethylene composition of the present invention has: (1) a much higher MRS than needed to qualify for a PE 112 classification, particularly a pipe member having a MRS of at least greater than 11.2 MPa; (2) a high SHM; and (3) a slow crack growth resistance close to, or meeting, the requirement of pipe products for trenchless installation.

The PE pressure pipes of the present invention has the general benefits of being lightweight, flexible, and higher strength, i.e., the pipes have an improved pressure resistance and operate at higher pressure. For example, the MRS of the pipe member is ≥11.3 MPa in one general embodiment, ≥3 MPa in another embodiment, ≥12 MPa in still another embodiment; ≥13 MPa in yet another embodiment; and >14 MPa in even still another embodiment. In other embodiments, the MRS of the pipe member is at a range of, for example, from 11.2 MPa to 13.99 MPa (e.g. similar to a PE125 category) in one general embodiment, from 11.2 MPa to 12 MPa in another embodiment, and from 11.2 MPa (e.g. similar to a PE112 category) to 11.7 MPa in still another embodiment.

Because of the higher MRS, the polyethylene composition of the present invention performs as well as or better than PE 100 and PE 112. And thus, the maximum allowable operating pressure (MAOP) of pipes made from the present invention composition can be increased and the wall thickness of the pipe can be reduced if desired. In one embodiment, the pipe product can have thick walls and large diameters, for example wall thicknesses of 3 mm up to 147 mm and diameters of 16 mm up to 2,500 mm.

In another embodiment, the pipe product made from the composition of the present invention has a high Stain Hardening Modulus (SHM); and a slow crack growth resistance close to the requirement of pipe products for trenchless installation. For example, the SHM of the pipe member is greater than 45 MPa in one general embodiment, greater than 53 MPa in another embodiment, and greater than 60 MPa in still another embodiment. In other embodiments, the SHM of the pipe member is from 45 MPa to 70 MPa in one general embodiment, from 45 MPa to 60 MPa in another embodiment, and from 45 MPa to 55 MPa in still another embodiment.

For example, the slow crack growth resistance of the pipe member manufactured from the composition is greater than 1,000 hr in one general embodiment, greater than 5,000 hr in another embodiment, and greater than 8,760 hr in still another embodiment. In one preferred embodiment, the resin can advantageously exceed the test time of 8,760 hr. In other embodiments, the slow crack growth resistance of the pipe member is from 1,000 hr to 8,760 hr in one general embodiment, from 5,000 hr to 8,760 hr in another embodiment, and from 6,000 hr to 8,760 hr in yet another embodiment; and in still another embodiment, the resin exceeds the test time of 8,760 hours.

It is theorized that the denser tie chains present in the final high strength polyethylene composition are achieved by introducing 1-octene to the composition through the carbon black masterbatch which is added onto existing tie chains due to the presence of 1-hexene in the base resin of the composition. As a result, the long-term creep performance of a pipe product manufactured using the composition of the present invention having 1-octene is much higher than a pipe product made from a composition without 1-octene. For example, a pipe product made using a same base resin formulation without 1-octene failed at <8,000 hr at an applied hoop stress of 5.66 MPa while a pipe product made using the composition of the present invention that has both 1-octene and 1-hexene can continue to maintain its integrity beyond >12,186 hr at an applied hoop stress of 5.91 MPa.

Some of the other properties of the pipe member include, for example, the pipe member having a density of from 0.955 g/cm3 to 0.966 g/cm3 in one embodiment, from 0.955 g/cm3 to 0.963 g/cm3 in another embodiment, and from 0.955 g/cm3 to 0.960 g/cm3 in still another embodiment.

The tensile strength at yield of the pipe member can be, for example, from 21 MPa to 35 MPa in one embodiment, from 21 MPa to 31 MPa in another embodiment, and from 21 MPa to 26 MPa in still another embodiment.

The resistance to slow crack growth of the pipe member can be, for example, >500 hr in one embodiment, from 1,000 hr to 8,760 hr in another embodiment, and from 5,000 hr to 8,760 hr in still another embodiment.

The resistance to rapid crack propagation (RCP) of the pipe member can be, for example, >10 bar at 0° C. in one embodiment, from 10 bar to 25 bar in another embodiment, and from 10 bar to 40 bar in still another embodiment. Resistant to RCP means “no crack propagation” or “crack arrest” under applied pressure and impact load as described in ISO 13477.

In combination with the above properties of the pipe member, the pipe member can also have a notched pipe strength of >500 hr in one general embodiment, and >8,760 hr in another embodiment. In other embodiments, the notched pipe strength can be from 1,000 hr to 8,760 hr in one embodiment, and from 5,000 hr to 8,760 hr in another embodiment.

In one preferred embodiment, the pipe member of the present invention exhibits a density of 0.958 g/cm3, a tensile strength at yield of ˜25 MPa, a resistance to slow crack growth of >500 hr, a resistance to rapid crack propagation (RCP) of >10 bar at 0° C., in combination with a notched pipe strength of >500 hr.

As aforementioned, the resulting PE plastic pipe is manufactured by extrusion and can be made in various sizes. For example, the diameter of the pipe can be from 1.6 cm to 250 cm; and the wall thickness of the pipe can be from 2.3 mm to 14.7 cm. The PE pipe can be made in rolled coils of various lengths or in straight lengths of up to 12 m. Generally small diameters (e.g., <15.2 cm OD) are coiled and large diameters (e.g., >15.2 cm OD) are in straight lengths.

In addition, the PE pipe can be made in many forms and colors, for example, (1) a single colored extrusion such as black pipe; (2) a black pipe with coextruded color striping; or (3) a black or natural pipe with a coextruded colored layer. Some of the common colors used in the plastic pipe industry to classify PE pipes include, for example, (1) completely black for potable water or industrial applications; (2) completely blue, or black with blue stripes, for potable water; and (3) completely yellow, or black with yellow stripes, for gas conduits.

As aforementioned, the composition of the present invention can be used to produce various PE articles. And, in one preferred embodiment, the article is a pipe member having a high MRS and can be used in high pressure applications. For example, the pipe having a high MRS can be used for underwater applications. The PE pipe of the present invention is easy to install, light, corrosion-free and has a service life of up to 100 years. For example, the resin composition of the present invention maintains an MRS of greater than 11.3 MPa extrapolated between the range of 50 years and 100 years at 20° C. In a preferred embodiment the resin maintains an MRS of greater than or equal to 11.5 MPa and maintains this MRS over an extrapolated lifetime between 50 and 100 years at 20° C.

In other embodiments, the pipe is useful in applications to convey various types of flowing substances including potable water, gas (fluids), and slurries; another embodiment comprises compression molded or extruded sheets that are assembled to containers by means of thermoplastic welding.

### EXAMPLES

The following Inventive Examples (Inv. Ex.) and Comparative Examples (Comp. Ex.) (collectively, “the Examples”) are presented herein to further illustrate the present invention in detail but are not to be construed as limiting the scope of the claims. Unless otherwise stated all parts and percentages are by weight.

Various terms and designations used in the Examples are explained as follows:
“MRS” stands for minimum required strength.
“MFR” stands for melt flow rate.
“I2” or MFR2 is MFR measured with 2.16 kg load at 190° C.
“I5” or MFR5 is MFR measured with 5.0 kg load at 190° C.
“I21” or MFR21 is MFR measured with 21.6 kg load at 190° C.
“BK” stands for black resin.
“NT” stands for natural resin (i.e., non-black resin).
“SHM” stands for stain hardening modulus.
“CB MB” stands for carbon black masterbatch.
“CM in CB MB” stands for comonomer in carbon black masterbatch.
“NA” stands for not applicable.
“CB Con.” stands for carbon black content.
“OIT” stands for oxidation induction time.
“ISO” stands for International Standardization Organization.

### Test Methods

The test methods used in the Examples are described as follows:

### Density

The procedure described in ASTM D792 is followed to measure the density of the polymers. Density is measured by the displacement (Archimedes) method. A sample is weighed in air (dry weight) and immersed in a fluid (wet weight). Knowing the density of the immersion fluid, the loss in weight of the sample on immersion allows the sample density to be calculated. The immersion fluid may be water (Method A) or other liquid (Method B).

A sheet of material is molded per the process described in ASTM D4703, Annex A.1, Procedure C. On removal the sheet from a press, three coupons (˜38 mm×˜12.7 mm×˜3 mm) are cut from the sheet. The density can be measured as either a ‘quick’ density (within 1 hour of molding) or as an annealed density (conditioned for 40+ hours at 23+/−2° C. and 50+/−10% relative humidity after molding). All the density reported in the Examples are measured using Method B and on an annealed sample.

Melt Flow Rate (I₂, I₅ and I₂₁)

The procedure described in ASTM D1238 is followed to determine the melt flow rate of a resin. This test method covers the determination of the rate of extrusion of molten thermoplastic resins using an extrusion plastometer. After a specified preheating time of 7 (+/−0.5) min, resin is extruded through a die with a specified length and orifice diameter under prescribed conditions of temperature, load, and piston position in the barrel. Method B of ASTM D1238 is used. Method B is an automatically timed method. Here, the sample is extruded from the melt index machine and the piston travel is timed over a pre-determined distance, the timing is performed automatically by a moveable arm position below the load frame. The pre-determined distance is 6.35 mm for a I2 of up to 10 g/10 min and 25.4 mm for a I2 of >10 g/10 min. The weight of the extrudate is determined from the volume (distance×bore area) and the melt density. The melt density is taken to be 0.7636 g/cm3 for polyethylene. The data are reported as MFR in g/10 min or dg/min. Samples can be run with loads of 21.6 kg, 5.0 kg or 2.16 kg (i.e., 121, 15 or 12, respectively).

### Gel Permeation Chromatography (GPC)

The chromatographic system used consists of a PolymerChar GPC-IR high temperature GPC chromatograph equipped with an internal IR5 infra-red detector (IR5). The autosampler oven compartment of the system is set at 160° C. and the column compartment of the system is set at 150° C. The columns used are four Agilent “Mixed A” 30 cm 20-micron linear mixed-bed columns. The chromatographic solvent used is 1,2,4 trichlorobenzene and contains 200 ppm of butylated hydroxytoluene (BHT). The solvent source is nitrogen sparged. The injection volume used is 200 microliters and the flow rate is 1.0 milliliters/minute.

Calibration of the GPC column set is performed with 21 narrow molecular weight distribution polystyrene standards with molecular weights ranging from 580 g/mol to 8,400,000 g/mol and are arranged in 6 “cocktail” mixtures with at least a decade of separation between individual molecular weights. A “decade of separation” means interval between two quantities having a ratio of 10 to 1. For example, 1.8 and 18 or 25 and 250 has a decade of separation. The standards are purchased from Agilent Technologies. The polystyrene standards are prepared at 0.025 g in 50 mL of solvent for molecular weights equal to or greater than 1,000,000 g/mol, and 0.05 g in 50 mL of solvent for molecular weights less than 1,000,000 g/mol. The polystyrene standards are dissolved at 80° C. with gentle agitation for 30 min. The polystyrene standard peak molecular weights are converted to polyethylene molecular weights using Equation (EQ1) (as described in Williams and Ward, J. Polym. Sci., Polym. Let., 6, 621 (1968)):

M_{polyethylene}=A×(M_{polystyrene})^{B} (EQ1)

where M is the molecular weight, A has a value of 0.4315 and B is equal to 1.0.
A fifth order polynomial is used to fit the respective polyethylene-equivalent calibration points. A small adjustment to A (from approximately 0.375 to 0.445) is made to correct for column resolution and band-broadening effects such that linear homopolymer polyethylene standard is obtained at a molecular weight of 120,000 g/mol.

The total plate count of the GPC column set is performed with decane (prepared at 0.04 g in 50 mL of trichlorobenzene (TCB) and dissolved for 20 min with gentle agitation.) The plate count (Equation (EQ2)) and symmetry (Equation (EQ3)) are measured on a 200-microliter injection according to the following equations:

$$Plate Count = 5.54 * {( \frac{( {RV}_{Peak Max}}{Peak Width at \frac{1}{2} height} )}^{2} \qquad ( EQ2 )$$

where RV is the retention volume in milliliters, the peak width is in milliliters, the peak max is the maximum height of the peak, and ½ height is ½ height of the peak maximum.

$$Symmetry = \frac{( Rear Peak {RV}_{one tenth height} - {RV}_{Peak max} )}{( {RV}_{Peak max} - Front Peak {RV}_{one tenth height} )} \qquad ( EQ3 )$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Samples are prepared in a semi-automatic manner with the PolymerChar “Instrument Control” Software, wherein the samples are weight-targeted at 2 mg/mL, and the solvent (contained 200 ppm BHT) is added to a pre nitrogen-sparged septa-capped vial, via the PolymerChar high temperature autosampler. The samples are dissolved for 2 hr at 160° C. under “low speed” shaking.

The calculations of Mn(GPC), and Mw(GPC), are based on GPC results using the internal IR5 detector (measurement channel) of the PolymerChar GPC-IR chromatograph according to Equations (EQ4)-(EQ5), using PolymerChar GPCOne™ software, the baseline-subtracted IR chromatogram at each equally-spaced data collection point (i), and the polyethylene equivalent molecular weight obtained from the narrow standard calibration curve for the point (i) from Equation (EQ1).

$${Mn}_{( GPC )} = \frac{{\sum }^{i} {IR}_{i}}{{\sum }^{i} ( {IR}_{i} / {M}_{{polyethylene}_{i}} )} \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 5 )$$

Polydispersity index is defined as Mw/Mn.

### Comonomer Content Using Nuclear Magnetic Resonance (NMR)

### Sample Preparation

The samples are prepared by adding ˜100 mg of sample to 3.25 g of 1,1,2,2-tetrachlorethane (TCE), with 25 wt % as TCE-d2 in a Norell 1001-7 10 mm NMR tube. The solvent contained 0.025 molar (M) Cr(AcAc)3 as a relaxation agent. Sample tubes are purged with N2, capped, and sealed with Teflon tape before heating and vortex mixing at 145° C. to achieve a homogeneous solution.

Data Acquisition Parameters

13C NMR is performed on a Bruker AVANCE 600 MHz spectrometer equipped with a 10 mm extended temperature cryoprobe. The data is acquired using a 7.8 second pulse repetition delay, 90-degree flip angles, and inverse gated decoupling, with a sample temperature of 120° C. All measurements are made on non-spinning samples in locked mode. Samples are allowed to thermally equilibrate for seven minutes prior to data acquisition. The 13C NMR chemical shifts are internally referenced to the EEE triad at 30.0 ppm. EEE means a sequence of three ethylene units.

### Data Analysis

Average of two peaks is used for hexene and then three others peaks that hexene and Octene have in common are examined. Hexene contribution is subtracted and then the difference is averaged.

### C13 NMR Comonomer Content (Generic Description+References)

It is well known to use NMR spectroscopic methods for determining polymer composition. ASTM D 5017-96, J. C. Randall et al., in “NMR and Macromolecules” ΔCS Symposium series 247, J. C. Randall, Ed., Am. Chem. Soc., Washington, D.C., 1984, Ch. 9; and J. C. Randall in “Polymer Sequence Determination”, Academic Press, New York (1977) provide general methods of polymer analysis by NMR spectroscopy.

### Strain Hardening Modulus (SHM)

ISO 18488 standard is followed to determine strain hardening modulus. Resin pellets are compression molded and then conditioned at 120° C. for one hour followed by a controlled cooling at a rate of 2° C./min to RT. Tensile bars (dog bone-shaped) are punched out of compression molded sheets. The tensile test is conducted at 80° C. and a non-contact extensometer is used to record the strain. As specified in ISO 18488, the Neo-Hookean Strain Measure (NHSM) and a true stress plot is used to calculate the slope between a draw ratio of 8 and 12. If failure occurred before a draw ratio of 12, then the draw ratio corresponding to the failure strain is considered as upper limit of the slope. If failure occurred before a draw ratio of 8.5, then the test is considered invalid. In the Examples, none of the samples failed before draw ratio of 8.5.

Various commercially available polyethylene resin products are described in Table I.

TABLE I
Properties of Polyethylene Products

| | | | Properties of Product | | |
|---|---|---|---|---|---|
| | | | (as listed in Producer's | | |
| | | | Technical Data Sheet) | | |
| | Brief | | | | Yield |
| | Description | | MRS | I₅ | Strength |
| Product | of Product | Producer of Product | (MPa) | (dg/min) | (MPa) |
| El-Lene HDPE H112 PC (BK) | HDPE | SCG Polymer | 11.3 | 0.20 | 24.5 |
| HDPE P6006AD (BK)⁽¹⁾ | HDPE | SABIC | >11.2 | 0.25 | 23.0 |
| Halene-H P5300 (NT)⁽²⁾ | HDPE | Haldia Petrochemicals | 11.2 | 0.23 | 26.0 |
| YEM-4902T⁽³⁾ | HDPE | Sinopec | 11.2 | 0.15-0.30 | 24.0 |

Notes for Table I:
⁽¹⁾Similar properties for PE100 grade.
⁽²⁾No black compound, MRS 11.2 with knee.
⁽³⁾Element's MRS 11.2 listing, no knee.

### Example 1 and Comparative Examples A-C: Compositions

### General Procedure for Making Compositions

The base resin used in the Examples and described in Table II includes a bimodal HDPE having high molecular weight (HMW) and low molecular weight (LMW) components. The HMW component is in the range of from 55 wt % to 65 wt % in the base resin. The HMW component is made in a first reactor and the LMW component is made in a second reactor connected in series with the first reactor. Antioxidants are added to the reactor grade resin collected from the second reactor; and then, a compound made with the antioxidant package and the reactor grade resin is pelletized.

The Masterbatch is based on a polyethylene component as a carrier, wherein the polyethylene has an ethylene copolymer of the group of C8 carbon atoms.

The final pipe resin composition which is prepared for extrusion is made by mixing the base resin and the Masterbatch on a continuous mixer typically used for polyolefin processing.

As described in Table II, Comp. Ex. A is a base resin and is used as received from a production line. The “base resin” is bimodal HDPE resin with HMW and LMW components having two molecular weight peaks in the molecular weight distribution as measured by GPC analysis.

Comparative Ex. B is the same base resin as Comparative Ex. A except that the resin is passed through an extruder to intentionally subject the resin to an additional thermal history. This thermal history is exactly the same when black compounds are produced, such as in Comp. Ex. C and Inv. Ex. 1. “Thermal history” herein refers to the compounding conditions on an extruder used in the Examples.

Comp. Ex. A and Comp Ex. B do not have any carbon black present in the compositions. Also, Comp. Ex. A and Comp Ex. B have 1-hexene comonomer present in the compositions and no 1-octene is present in the compositions.

Comp. Ex. C has carbon black; and 1-hexene and 1-butene comonomers are present in the composition while Inv. Ex. 1 has carbon black; and 1-hexene and 1-octene comonomers are present in the composition.

TABLE II
Compositions of Examples

| Example No. | Formulation | CM in CB MB | CB Con. (wt %) |
|---|---|---|---|
| Comp. Ex. A | Base resin | NA⁽³⁾ | NA |
| Comp. Ex. B | Base resin | NA | NA |
| Comp. Ex. C | Base resin + CB MB#1⁽¹⁾ | 1-Butene | 2.25 |
| Inv. Ex. 1 | Base resin + CB MB#2⁽²⁾ | 1-Octene | 2.25 |

Notes for Table II:
⁽¹⁾The carrier resin used in CB MB#1 has 1-butene comonomer.
⁽²⁾The carrier resin used in CB MB#2 has 1-octene comonomer.
⁽³⁾NA = not applicable.

As aforementioned, Comp. Ex. C has 1-butene and 1-hexene comonomer and Inv. Ex. 1 has 1-hexene and 1-octene comonomer. The comonomer content of these two Examples are described in Table III. The comonomer content of the compositions was measured using NMR (Nuclear Magnetic Resonance) spectroscopy.

TABLE III
Comonomer Content of Examples

| | C2 branches/1,000 C | C4 branches/1,000 C | C6 branches/1,000 C |
|---|---|---|---|
| Sample | (Butene) | (Hexene) | (Octene) |
| Comp. | 0.70 | 1.91 | None |
| Ex. C | | | |
| Inv. | None | 1.99 | 0.28 |
| Ex. 1 | | | |

MFR21 and MFR2 of all the three components (a)-(c) of the composition were measured separately using ASTM D1238. Similarly, the density of the components was measured using ASTM D792. These two properties are described in Table IV. Triple detector compositional GPC was conducted on the final formulation of Inv. Ex. 1 and deconvoluted to determine the average molecular weight and polydispersity index of individual components.

TABLE IV
Properties of Polyethylene Components of Formulation
HMW Component of Bimodal Base Resin

| MFR₂₁ (I₂₁) | Density | | Mw | |
|---|---|---|---|---|
| (dg/min) | (g/cm³) | Wt % | (g/mol) | Polydispersity Index |
| 0.395 | 0.928 | 55.68 | 486,526 | 5.67 |

LMW Component of Bimodal Base Resin

| MFR₂ (I₂) | Density | | Mw | |
|---|---|---|---|---|
| (dg/min) | (g/cm³) | Wt % | (g/mol) | Polydispersity Index |
| 967 | 0.9709 | 38.69 | 25,290 | 3.93 |

MMW Component of Final Formulation

| MFR₂ (I₂) | Density | | Mw, | |
|---|---|---|---|---|
| (dg/min) | (g/cm³) | Wt % | (g/mol) | Polydispersity Index |
| 1 | 0.920 | 3.38 | 121,141 | 4.508 |

Note for Table IV:
The content of carbon black in the final formulation is 2.25 wt %.

The MFR2 and density of the final formulation was measured using ASTM standard D1238 and D792, respectively. The average molecular weight and polydispersity index properties were obtained using Gel Permeation Chromatography (GPC). These properties of the final formulation of Inv. Ex. 1 are described in Table V.

TABLE V
Properties of Final Formulation of Inv. Ex. 1
Final Composition

| MFR₂ (I₂) | Density | Mw | |
|---|---|---|---|
| (dg/min) | (g/cm³) | (g/mol) | Polydispersity Index |
| 0.08 | 0.958 | 228,360 | 15.3 |

### Example 2 and Comparative Examples D-F: Tensile Bar Samples

The strain hardening modulus (SHM) of several tensile bar samples made from the compositions described in Table VI was measured according to ISO 18488 standard using the procedure described in the Test Method section above.

TABLE VI
Performance of Tensile Bar Testing Samples

| Tensile Bar | Composition Example No. | SHM |
|---|---|---|
| Example No. | Used for Making Tensile Bar | (MPa) |
| Comp. Ex. D | Comp. Ex. A | 58 |
| Comp. Ex. E | Comp. Ex. B | 55 |
| Comp. Ex. F | Comp. Ex. C | 50 |
| Comp. Ex. G | El-Lene HDPE H112 PC | 48 |
| | (commercial grade resin) | |
| Inv. Ex. 2 | Inv. Ex. 1 | 54 |

From the results described in Table VI, it is found that addition of carbon black into the composition of Inv. Ex. 1 does not drop the SHM when compared with the composition of Comp Ex. B when these two compositions have the same thermal history. However, addition of carbon black in Comp. Ex. C drops the SHM by ˜10%. This drop in SHM is due to the difference in the combination of comonomers and hence the tie chain densities. The composition of the Examples and comonomer content is described in Table II.

### Example 3 and Comparative Examples H-I: Pipe

### General Procedure for Making Pipe Test Samples

The resin compositions made by the procedure described above and described in Table VII are extruded by means of a pipe extrusion process to form a pipe sample for testing. The extrusion process of making pipes is a well-known process in the field of pipe manufacturing. For the MRS determination, pipes of a size of 032 mm×3 mm are extruded. The dimension “032 mm” is the outer diameter of the pipes and the dimension “3 mm” is the wall thickness of the pipes. This pipe dimension is a typical size for pipe testing and the testing is carried out according to EN Standard 12201-2 (a European standard).

The pipe extrusion of a general purpose HDPE is made on an extrusion line having a 045 mm screw and L/D ratio of 28. The temperature setting of the extruder is 200° C. for the 4 extruder zones, 200° C. for the adapter flange and 200° C. for the extrusion head. A water-cooled hopper zone is used during the extrusion process. The extrusion head of the extruder used is a spider head; and the die geometry is a die having a diameter of 38.4 mm and a pin diameter of 30.9 mm. The calibration of a pipe having a 033.1 is done with a conventional disc calibration unit and a vacuum tank where a vacuum of 0.3 bar is applied.

The line speed is 3.5 m/min with a screw rpm of 70 (min-1) and a resulting extruder pressure of 194 bar and a mass temperature of 190° C. The downstream equipment consists of 1 vacuum tank and two cooling tanks with spray cooling. The tubes are cut by a Graewe pipe cutting unit and a Graewe caterpillar is used.

For slow crack growth tests (SCG) on a pipe sample, the pipe sample is extruded with the extruder as described above with adaption of the tooling and a calibration unit with a diameter of 0113.25 mm is used and a water thank equipped to accommodate the pipe of an outer diameter of 0110 mm and a wall thickness of 10 mm is used. It is known by those skilled in the art that a pipe made for testing can be made having an outer diameter than 0110 mm and a wall thickness of 10 mm following the EN 12201 standard.

General Procedure for Testing Pipe Samples

The pipes samples are tested at Element, a generally recognized testing institute in the piping industry, for determining the long-term hoop stress performance of a resin. The tests are performed according to ISO 1167 (Part 1 and Part 2). The following three temperatures are used for the regression: 20° C., 60° C. and 80° C. Testing times of 10,000 hr and beyond 10,000 hr are reached by the resin at each temperature selected without showing brittle failure or a knee. The calculation of the MRS value for the resin is made according to the procedure in ISO 9080.

Slow crack growth on a pipe sample is created following the notched pipe testing procedure according to ISO 13479. A pressure of 9.2 bar is used on pre-notched pipes at 80° C. in a water tank. The wall thickness of the pipe sample at the notched section for testing is between 0.78 to 0.82× the minimum wall thickness of the un-notched section of the pipe sample according to ISO 13479.

The MRS of the compositions described in Table VII was measured using a 32-mm pipe as per the procedure described in ISO9080-2012.

TABLE VII
Performance of Testing Pipe Samples

| Pipe Sample | Composition Example No. | |
|---|---|---|
| Example No. | Used for Making Pipe Sample | MRS |
| Comp. Ex. H | Comp. Ex. C | <11.0 MPa |
| Comp. Ex. I | El-Lene HDPE H112 PC | 11.3 MPa |
| | (commercial grade) | |
| Inv. Ex. 3 | Inv. Ex. 1 | 11.7 MPa |

Table VIII describes various physical properties measured on test specimens where the properties of density, OIT, 12, 15, 121, and CB content are measured on the resin composition of Inv. Ex. 1; and the SHM property is measured on a plaque test piece made from the composition of Inv. Ex. 1. Both ASTM and ISO standards were used to determine density, oxidation induction time (OIT), melt flow rate at various loads (e.g., at 2.16 kg, 5.0 kg and 21.6 kg), and carbon black content. The procedure described in ISO18488 was followed to measure the SHM which represents the slow crack growth resistance of the polymer.

TABLE VIII
Physical Properties of Inv. Ex. 1

| Property Measured | Unit | Test Standard Used | ASTM | ISO |
|---|---|---|---|---|
| Density | g/cm³ | ASTM D792/ISO | 0.9588 | — |
| | | 1183 | | |
| OIT (@ 200° C.) | Minutes | ASTM D3895/ISO | 88 | — |
| | | 11357-6 | | |
| I₂ (@ 2.16 kg and | dg/min | ASTM D1238/ISO | 0.08 | — |
| 190° C.) | | 1133 | | |
| I₅ (@ 5.0 kg and | dg/min | ASTM D1238/ISO | 0.31 | — |
| 190° C.) | | 1133 | | |
| I₂₁ (@ 21.6 kg and | dg/min | ASTM D1238/ISO | 7.34 | — |
| 190° C.) | | 1133 | | |
| Strain Hardening | MPa | ISO 18488 | — | 54 |
| Modulus (SHM) | | | | |

An I5 measurement of 0.31 dg/min described in Table VIII indicates that the flowability of the composition of Inv. Ex. 1 will be better as compared to the other PE 112 resins described in Table I. All the commercial PE 112 grades have 15 of less than 0.31 dg/min.

An SHM measurement of 54 MPa for the composition of Inv. Ex. 1 indicates that the composition is in an ISO standard category of product that can be used for trenchless installation. Other commercial PE 112 resins, such as El-Lene HDPE H112 PC, has an SHM of 48 MPa which is at least 10% less than the SHM of Inv. Ex. 1.

What is claimed is:

1. A high strength multimodal polyethylene composition useful for manufacturing a plastic article therefrom, the composition comprising a mixture of:
(a) at least one first polymer resin comprising a high molecular weight copolymer resin having a molecular weight of greater than 350,000 g/mol and a density of from 0.920 g/cm³ to 0.935 g/cm³, wherein the first polymer resin is a reaction product of an ethylene and a first comonomer;
(b) at least one second polymer resin comprising a low molecular weight homopolymer resin having a molecular weight of less than 30,000 g/mol and a density of greater than 0.965; and
(c) at least one third polymer resin comprising a medium molecular weight copolymer resin having a molecular weight of from 50,000 g/mol to 150,000 g/mol and a density of 0.915 g/cm³ to 0.925 g/cm³, wherein the third polymer is a reaction product of an ethylene and a second comonomer different from the first comonomer; and wherein the second comonomer has longer short-chain branches with carbon atoms of greater than C4 than the first comonomer; and wherein the high strength multimodal polyethylene composition has a minimum required strength of greater than 11.3 MPa.

2. The composition of claim 1, wherein the first comonomer is 1-hexene and wherein the second commoner is 1-octene.

3. The composition of claim 1, wherein the high strength multimodal polyethylene composition has minimum required strength of from 11.3 MPa to 13 MPa.

4. The composition of claim 1, wherein the high strength multimodal polyethylene composition has minimum required strength of from 11.3 MPa to 11.7 MPa.

5. The composition of claim 1, wherein the high strength multimodal polyethylene composition is a trimodal polyethylene composition.

6. The composition of claim 1, further including (d) a carbon black material; wherein the carbon black material is sourced from a carbon black masterbatch comprising a blend of carbon black and a carrier polymer resin, wherein the carrier polymer resin is the at least one third polymer resin, component (c).

7. The composition of claim 1, wherein the at least one first polymer resin is an ethylene copolymer; wherein the at least one second polymer resin is an ethylene homopolymer; and wherein the at least one third polymer resin is an ethylene copolymer.

8. The composition of claim 1, wherein the concentration of the at least one first polymer resin is from 50 weight percent to 60 weight percent; wherein the concentration of the at least one second polymer resin is from 35 weight percent to 45 weight percent; and wherein the concentration of the at least one third polymer resin is from 2 weight percent to 5 weight percent.

9. The composition of claim 6, wherein the concentration of the carbon black material is from 2 weight percent to 2.5 weight percent.

10. A process for producing a high strength multimodal polyethylene composition useful for manufacturing a plastic article, the process comprising admixing:
(a) at least one first polymer resin comprising a copolymer resin having a molecular weight of greater than 350,000 g/mol;
(b) at least one second polymer resin comprising a homopolymer resin having a molecular weight of less than 30,000 g/mol; and
(c) at least one third polymer resin comprising a copolymer resin having a molecular weight of from 50,000 g/mol to 150,000 g/mol;
wherein the high strength multimodal polyethylene composition has minimum required strength of greater than 11.3 MPa.

11. A process for producing a pipe article comprising the steps of:
(i) providing a high strength trimodal polyethylene composition useful for manufacturing the pipe article therefrom, the composition comprising a mixture of:
(a) at least one first polymer resin comprising a copolymer resin having a molecular weight of greater than 350,000 g/mol;
(b) at least one second polymer resin comprising a homopolymer resin having a molecular weight of less than 30,000 g/mol; and
(c) at least one third polymer resin comprising a copolymer resin having a molecular weight of from 50,000 g/mol to 150,000 g/mol; wherein the high strength multimodal polyethylene composition has minimum required strength of greater than 10 MPa; and
(ii) processing the composition of step (i) into a pipe member using an extrusion process to form the pipe article; wherein the pipe article has a minimum required strength of greater than 11.3 MPa.

12. A pipe article produced by the process of claim 11.

13. A pipe article with a slow crack growth performance outperforming 6,000 hours tested according to ISO 13479.

14. The pipe article of claim 13, wherein the slow crack growth performance is greater than or equal to 8,760 hours.
